(19) United States
(12) Patent Application Publication
(10) Pub. No.: US 2025/0126320 A1
(43) Pub. Date: Apr. 17, 2025

(54) TEMPORAL REDISTRIBUTION OF NETWORK PACKET PAYLOADS TO REDUCE IMPACT TO PERCEIVED VIDEO QUALITY

(71) Applicant: NVIDIA Corporation, Santa Clara, CA (US)

(72) Inventors: Johannes Zimmermann, Berlin (DE); Andrija Bosnjakovic, Redmond, WA (US); Harsh Maniar, Sunnyvale, CA (US)

(73) Assignee: NVIDIA Corporation, Santa Clara, CA (US)

(21) Appl. No.: 18/485,475

(22) Filed: Oct. 12, 2023

(51) Int. Cl. H04N 21/4402

(52) U.S. Cl. CPC H04N 21/440236

(57) ABSTRACT

In various examples, systems and methods are disclosed relating to improving perceived video quality through temporal redistribution of network packet payloads that may carry error mitigation data. A subset of network packets for an encoded video stream is identified from a sequence of network packets as corresponding to a region of a video frame of the encoded video stream. A transmission order for the sequence of network packets is determined based at least on the subset of network packets and one or more error correction packets corresponding to the sequence of network packets. The sequence of network packets is transmitted to a receiver client device according to the transmission order.

### BACKGROUND

Video streaming involves encoding and transmitting video data over a network to a remote client device, which subsequently decodes the video. One drawback to video streaming is the occurrence of lost video data during streaming, which may be caused by factors such as packet loss and network transmission jitter. Error mitigation techniques, such as the transmission of forward error correction (FEC) packets, may reduce instances of lost data in video streams. However, transmission of such error mitigation data for the entire video payload may reduce available bandwidth for video in low-latency streaming applications, such as game streaming.

### SUMMARY

Embodiments of the present disclosure relate to improving perceived video quality through temporal redistribution of network packet payload, a subset of which may carry error mitigation data, such as FEC packets. Conventional systems transmit error mitigation packets generated for the entirety of a video stream, and therefore increase overall consumption of network bandwidth, which can result in higher latency, slower transmission speeds, and lower available bitrate for video quality. Such approaches are particularly vulnerable to “burst losses,” which are losses where ranges of packets in a sequence are lost, rather than individual packets of a sequence, because burst losses tend to affect packets towards the end of a sequence. The techniques described herein reduce the perceived impact to a video streaming application by automatically reordering packets in a sequence to improve the likelihood that packets containing “important” or “relevant” video regions, or error correction data for said regions, will reach its destination. Important or relevant video regions may be regions of video frames that a user is likely to focus on.

At least one aspect relates to a processor. The processor can include one or more circuits. The one or more circuits can identify, from a sequence of network packets corresponding to an encoded video stream, a subset of network packets corresponding to a region of a video frame of the encoded video stream. The one or more circuits can determine a transmission order for the sequence of network packets based at least on the subset of network packets and one or more error correction packets corresponding to the sequence of network packets. The one or more circuits can transmit the sequence of network packets to a receiver client device according to the transmission order.

In some implementations, the one or more circuits can reorder one or more payloads of the sequence of network packets according to the transmission order prior to encoding the sequence of network packets for transmission. In some implementations, the one or more circuits can reorder one or more packets of the sequence of network packets according to the transmission order prior to transmitting the sequence of network packets to the receiver client device. In some implementations, the one or more circuits can generate the one or more error correction packets based at least on the encoded video stream for inclusion in the sequence of network packets. In some implementations, the one or more circuits can determine the transmission order for the sequence of network packets further based at least on a number of the one or more error correction packets.

In some implementations, the one or more error correction packets are related to the subset of the network packets. In some implementations, the one or more circuits can determine the transmission order such that the subset of network packets or the one or more related error correction packets are transmitted prior to other packets of the sequence of network packets. In some implementations, the one or more circuits can determine the transmission order such that a first set of packets corresponding to a first unprioritized region of the video frame is interleaved with a second set of packets corresponding to a second unprioritized region of the video frame.

In some implementations, the one or more circuits can determine the transmission order further based at least on a length of the sequence of network packets. In some implementations, the one or more circuits can determine the transmission order such that one or more of the subsets of network packets are separated by one or more other packets of the sequence of network packets. In some implementations, the one or more circuits can determine a number of the one or more other packets according to a number of the subset of network packets.

At least one aspect relates to a system. The system can include one or more processing units. The system can include one or more memory units storing instructions that, when executed by the one or more processing units, cause the one or more processing units to execute operations. The operations include identifying, from a sequence of network packets corresponding to an encoded video stream, a subset of network packets corresponding to a region of a video frame of the encoded video stream. The operations include determining a transmission order for the sequence of network packets based at least on the subset of network packets and one or more error correction packets corresponding to the sequence of network packets. The operations include transmitting the sequence of network packets to a receiver client device according to the transmission order.

In some implementations, the operations include generating the one or more error correction packets based at least on the encoded video stream for inclusion in the sequence of network packets. In some implementations, the operations include determining the transmission order for the sequence of network packets further based at least on a number of the one or more error correction packets. In some implementations, the operations include determining the transmission order such that at least one of the subset of the network packets or the one or more related error correction packets are transmitted prior to other packets of the sequence of network packets.

In some implementations, the operations include determining the transmission order such that a first set of packets corresponding to a first unprioritized region of the video frame are interleaved with a second set of packets corresponding to a second unprioritized region of the video frame. In some implementations, the operations include determining the transmission order further based at least on a length of the sequence of network packets. In some implementations, the operations include determining the transmission order such that one or more of the subsets of network packets are separated by one or more other packets of the sequence of network packets.

At least one aspect is related to a method. The method can include identifying, by using one or more processors, from a sequence of network packets corresponding to an encoded video stream, a subset of network packets corresponding to a region of a video frame of the encoded video stream. The method can include determining, using the one or more processors, a transmission order for the sequence of network packets based at least on the subset of network packets and one or more error correction packets corresponding to the sequence of network packets. The method can include transmitting, using the one or more processors, the sequence of network packets to a receiver client device according to the transmission order.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for three-dimensional (3D) assets, a system for performing deep learning operations, a system implemented using an edge device, a system implemented using a robot, a system for performing conversational AI operations, a system for generating synthetic data, a system incorporating one or more language models, a system incorporating one or more virtual machines (VMs), a system implemented at least partially in a data center, or a system implemented at least partially using cloud computing resources.

### BRIEF DESCRIPTION OF THE DRAWINGS

The present systems and methods for improving perceived video quality through temporal redistribution of network packet payloads that may carry error mitigation data are described in detail below with reference to the attached drawing figures, wherein:

FIG. 1 is a block diagram of an example system for improving perceived video quality through temporal redistribution of network packet payloads that may carry error mitigation data, in accordance with some embodiments of the present disclosure;

FIG. 2A depicts an example diagram of a video frame constructed from encoded regions that may be rendered by the system shown in FIG. 1, in accordance with some embodiments of the present disclosure;

FIG. 2B depicts an example diagram showing how different types of packets in a sequence of network packets may be reordered to maximize burst loss robustness, in accordance with some embodiments of the present disclosure;

FIG. 3 is a flow diagram of an example of a method for improving perceived video quality through temporal redistribution of network packet payloads that may carry error mitigation data, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods that reduce the impact of lost packets on the perceived quality of streamed video by changing the order of payload of network packets that are carrying this video. At a high level, the network packet redistribution techniques described herein can be performed by a streaming server that provides a video stream to a receiver client device. In some implementations, the video stream can be provided as part of a remote gaming application, and may be streaming in real-time or near real-time in response to input via the receiver device.

To improve streaming performance and reduce latency for the video stream, the streaming server may utilize a transmission protocol that does not ensure successful delivery of data packets to the client device. One example of such a protocol is the UDP protocol. Protocols such as the user datagram protocol (UDP) may not include built-in error correction, retransmission, or flow control mechanisms that ensure the successful and in-order delivery of data packets, and instead prioritize speed and simplicity over reliability and in-order delivery. When transmitting streaming video via a streaming protocol such as the real-time transport protocol (RTP), individual video frames may be transmitted in sequences of network packets, with each packet including one or more regions (e.g., slices, tiles, contiguous sequence(s) of macroblocks, any other logical sub-unit of a video frame that may be encoded as a distinct part of the encoded video frame's bitstream and decoded as a distinct part of the decoded video frame's data, etc.) of the video frame. If packets in a sequence are lost, only portions of video frames may be ultimately received at the client device for rendering. One type of packet loss experienced when transmitting packets via UDP is “burst loss,” where an entire range within a sequence of packets is lost at once due to an intermediary network device being unable to relay network packets for a limited amount of time.

In some implementations, the streaming server may implement error correction techniques, such as FEC, which involves transmitting additional error correction data along with the original data packets that include the video stream. The client device receiving the video stream from the streaming server uses this additional data to correct for errors (e.g., data corruption) or lost packets that may have occurred during transmission. Burst losses in packet transmission protocols may occur more frequently for packets in corresponding to the end of a frame packet sequence. To mitigate packet loss and improve the chances of recovering important network packets, the streaming server may, in some implementations, redistribute packets deemed more important closer to the start of a sequence of network packets. For example, such packets may include packets with selected frame regions and/or packets with error correction data corresponding to selected frame regions.

In certain video streaming applications such as remote game streaming, users are expected to pay more attention to certain regions of the display while paying less attention to other, subjectively less important (e.g., unprioritized) regions. Examples of regions that users may find more important include regions near the center of the video, near certain edges of the video, or certain corners of the video, among others. Such regions of interest may be application-specific and configured statically or may be determined dynamically by the streaming server. Therefore, certain network packets that transport video streaming data may include information that is more important to a user than other network packets.

Important or relevant regions of the video stream may be any region of the frame that is perceptually important, perceived by user to be important or critical, or is designated as relevant by an application that generates the video frames. The important or relevant regions may be regions of frames of the video stream that a user is more likely to focus on, relative to other regions of the frames. The important or relevant regions may be regions of frames of the video stream that are more frequently updated with new information, relative to other regions of the video stream. The systems and methods described herein leverage that certain packets may transport information that is more important than other packets to redistribute packets in a sequence to reduce the impact of packet loss on perceived quality of the video stream.

In some implementations, the streaming server can temporally distribute certain selected network packets in a manner that mitigates losses of said packets within sequences of network packets. The selected network packets can include packets that store video data corresponding to regions of video frames that are more relevant to a user. The reordering of such network packets may yield a relatively higher expected average number of important network packets that are not lost in transport, facilitating error correction and packet recovery. This may enable the client device to present video frames of the video stream faster without necessarily requiring retransmission of lost packets.

The streaming server may implement additional or alternative packet redistribution approaches. In this context, both packets carrying the bitstream pertaining to subjectively important regions and packets carrying error correction information are referred to as important. In one example, these important network packets may be redistributed uniformly throughout a sequence of network packets and interleaved with the rest of the packets of the same video frame. In some implementations, the streaming server may redistribute packets in a sequence for a video frame to maximize robustness against burst loss.

To do so, the streaming server can interleave clusters of important packets with other packets to maximize the temporal distance between important packets. The temporal distance between groups of important packets may be determined based on the number of important packets in the sequence or on observed behavior of the utilized network between the sender and the receiver. In some implementations, the streaming server may redistribute packets based on the regions of a video frame to which the packets correspond. For example, assuming that the top and bottom portions are determined to be of the same, comparatively lower importance, the streaming server may interleave packets that store video frame data corresponding to these portions of the frame, to result in symmetric tearing if a burst loss occurs during transmission.

The interleaved packets can then be reordered by the device that is receiving the video stream for presentation. In some implementations, the interleaved packets may be reordered according to a sequence number included in each network packet in the sequence. For example, the streaming server may change the order of the payloads of the network packets by transmitting the packet sequence with unaltered packet sequence numbers (e.g., RTP sequence numbers, etc.) in an intentionally altered order of transmission, which are then reordered in correct logical order by the receiver device based on the sequence numbers. In some implementations, the streaming server may change the order of the payloads in the sequence of network packets by redistributing network packet payloads across the sequence of network packets of the streamed video, and including additional metadata in the stream that includes a mapping between the packet sequence numbers of the transmission order to the packet sequence numbers of the logical order of the frame, so that the receiver device can utilize the mapping to reconstruct the received video frames of the video stream in the logical order.

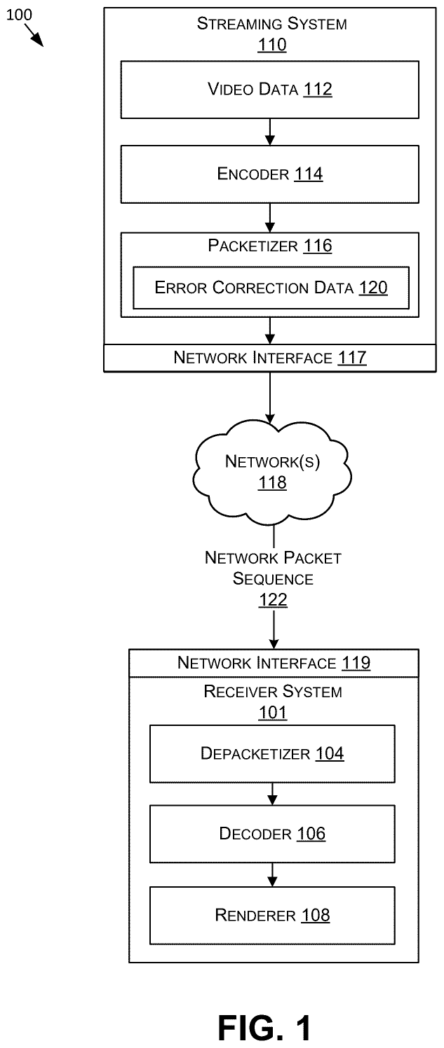

With reference to FIG. 1, FIG. 1 is an example computing environment including a system for improving perceived video quality through temporal redistribution of network packet payloads that may carry error mitigation data and/or encoded video data from important frame regions, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

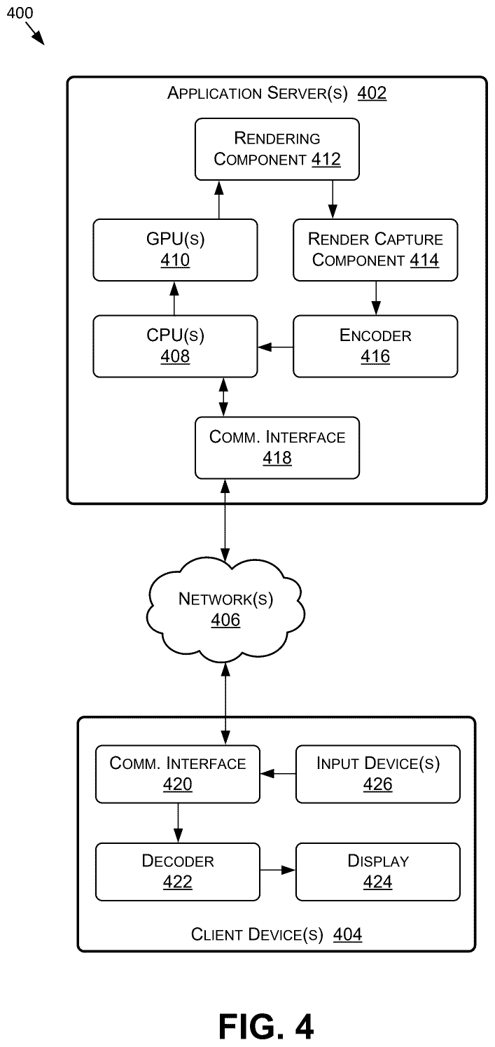

The system 100 can be utilized to provide (e.g., stream) video data 112 and error correction data 120 as part of the network packet sequence 122 via the network 118 to a receiver system 101. The network 118 may include any of the structure and implement any of the functionality of the network(s) 406 described in connection with FIG. 4. The packets in the network packet sequence 122 may be reordered according to the techniques described herein, such that the impact of burst loss on the perceived quality of certain portions of the videos stream is minimized. The network packets in the network packet sequence 122 may be reordered such that error correction data 120, as well as other selected regions of a video frame are less likely to be lost in the event of burst loss or other types of packet loss that may occur in the network 118.

The receiver device 101 can receive the network packet sequence 122, and can automatically reorder the packets in the network packet sequence 122 to correspond to the logical order of payload data to reconstruct the video frame. In the event of packet loss, the receiver device 101 can utilize the error correction data 120 to recover one or more lost or corrupted packets of the network packet sequence 122. The video data 112 may correspond to video frames of a video stream generated from any suitable source, including a video playback process or a gaming process (e.g., video output from remotely executing video games), among other sources of video data. In some implementations, the streaming system 110 can execute one or more applications or games that generate the video data 112.

The video data 112 can be generated as an output of any process that generates frames of video information. In some implementations, the video data 112 may be generated as an output of a rendering process for a video game executed by the streaming system 110. In a remote gaming configuration, the streaming system 110 may execute one or more game applications and may receive input data transmitted from the receiver system via the network 118 to control the game applications. Frames of the video data 112 may be generated at a variable or predetermined frame rate, including but not limited to thirty frames-per-second, sixty frames-per-second, or so on.

The encoder 114 of the streaming system 110 can encode the video data into a suitable format for transmission by generating an encoded bitstream (sometimes referred to herein as an “encoded video stream”) according to one or more codec standards. Encoding the video data 112 reduces the overall amount of information that is to be transmitted to the receiver system 101. The encoder 114 may utilize any combination of hardware or software to encode the video data 112. Encoding the video data 112 can include converting the video data 112 to conform to any suitable video codec standard, including but not limited to an AVC (or h.264), HEVC (or h.265), VVC (or h.266), VP8, VP9, or AV1, or any other video codec standard that supports geometric regions of a video frame. Similar codec standards may be utilized to encode audio data. The encoder 114 can generate the encoded bitstream continuously, for example, as frames are generated by an application or source of the video data 112. The encoder 114 may generate the encoded bitstream to include a chronological sequence of encoded video frames.

Encoding the video data 112 may include segmenting each video frame of the video data 112 into one or more regions. The encoder 114 can then encode each slice or tile to be included in the encoded bitstream, where each encoded slice or tile therefore corresponds to a respective region of a video frame. The geometry of the regions may be rectangular portions of the video frame, which may have the same width as the video frame (e.g., a horizontal slice), or may be a rectangular tile of the video frame. To render an encoded bitstream, a downstream decoder (e.g., the decoder 106 described in further detail herein) can decode each encoded slice or tile of the encoded bitstream and provide the decoded data to a renderer (e.g., the renderer 108) to generate a complete video frame. In some implementations, each encoded slice or tile of the encoded bitstream may be a single decodable unit of encoded video data, which may be rendered independently from other encoded regions of a video frame.

The encoder 114 can perform various compression techniques to encode the video data 112. For example, the encoder 114 may perform intra-frame compression techniques, inter-frame compression techniques, and rate control compression techniques, including but not limited to motion estimation, quantization, and entropy coding. In some implementations, the encoded bitstream may include audio data, which may be generated by the encoder 114 using a suitable audio encoding process. In some implementations, audio data may be formatted as a separate bitstream.

In some implementations, the encoder 114 can determine whether generated regions (e.g., slices or tiles) of a video frame of the video data 112 include selected content, which may be relevant or important content which an end-user is likely to focus on (sometimes referred to herein as “selected content” or “selected regions”). For example, in a remote gaming application, the end-user may be more likely to focus on the center or certain edges of the video frame, because these regions may include data that is more relevant to gameplay than other regions. Any number of regions of the video frame may be indicated as important or relevant (e.g., selected) portions. Unselected regions of the video frame may be regions of the video frame to which a user is less likely to focus on, or may include information that is updated on a less frequent basis, and may be referred to herein as “irrelevant” or “unimportant” regions.

To determine whether a region is an important region, when dividing a video frame of the video data 112 into discrete regions (e.g., slices or tiles), the encoder 114 can compare the location (e.g., coordinates) of each slice or tile to a set of coordinates that indicate a selected region. If the location of the slice or tile is within the coordinates that indicate a selected (e.g., important or relevant) region, the encoder 114 can flag the slice or tile as a selected region of the frame. In some implementations, the encoder 114 can generate the encoded bitstream to include metadata that indicates whether and which encoded regions are selected. In some implementations, the encoder 114 can generate the encoded bitstream without such indication but will then also generate the metadata about selected regions as an accompanying data structure of the encoded bitstream.

In some implementations, the coordinates of selected regions are predetermined and application-agnostic. In some implementations, the coordinates of selected regions of frames of the video data 112 may be application-specific and may be stored in association with the application producing the video data 112. For example, the application producing the video data 112 (e.g., a game application rendering frames of the video data 112) may be stored in association with one or more configuration settings or files that indicate which portions (e.g., coordinates) of the frames of video data 112 are most relevant or most important for streaming. The encoder 114 can retrieve the information corresponding to the application to flag corresponding regions as selected.

In some implementations, the coordinates of the frames of the video data 112 may be dynamically determined. For example, as the application rendering frames of the video data 112 is executed, the portions of the screen to which a user is most likely to focus on may change. To compensate for these changes, the encoder may access a set of coordinates that indicate the important regions of the frame based at least on the current state of the application. The state of the application may be provided by the application, may be determined by the encoder via one or more application programming interface (API) calls, or may be determined based at least on the frames of the video data 112 produced by the application. As new frames of the video data 112 are rendered, the encoder 114 can access the most up-to-date coordinates for the current state of the application to dynamically determine which portions of the frames of the video data 112 are selected.

Flagging the encoded regions of a video frame as selected may include generating metadata that is separate from the encoded bitstream, which is provided to the packetizer 116 to reorder the network packet sequence 122 generated by the packetizer 116, as described herein. In some implementations, the encoder 114 may insert or otherwise include indications that an encoded region of a frame is important or relevant within the encoded bitstream generated by the encoder 114. Once the encoder 114 has generated the encoded bitstream, the encoded bitstream, and any indications of selected encoded regions, can be provided as input to the packetizer 116, which can then generate the network packet sequence 122 having payload data that carries the encoded bitstream generated by the encoder 114.

To generate the network packet sequence 122, the packetizer 116 can divide the encoded bitstream into one or more portions, and can include the portions in each payload of the network packet sequence 122. The network packet sequence 122 may include, for example, UDP packets or other suitable transport-level packets. The payload of each network packet in the network packet sequence 122 may include one or more streaming protocol packets, which themselves include the portions of the encoded bitstream in their respective payloads. The streaming protocol packets may be generated, for example, according to the RTP protocol, or any other protocol that provides a mapping between portions/parts of frame regions and streaming protocol packets.

To generate the network packet sequence 122, the packetizer 116 can divide the encoded bitstream into portions that are each included in payloads of respective RTP packets. In some implementations, an RTP packet payload may include encoded information (e.g., a portion of the encoded bitstream) corresponding to a portion of or a complete single region (e.g., a single slice or tile) of a frame of the video data 112. In some implementations, an RTP packet payload may include encoded information corresponding to multiple regions of a frame of the video data 112 (e.g., multiple slices or tiles).

In an example implementation utilizing RTP, the packetizer 116 may generate a mapping between each RTP packet and its corresponding frame region of video data by including a sequence number in the header of each RTP that indicates the order in which the packets should be arranged for decoding and rendering. The sequence number may be utilized by the downstream depacketizer 104 to identify which packets in the network packet sequence 122 have been dropped, if any. In some implementations, additional data (e.g., metadata) may be included in the network packets of the network packet sequence 122 that designate an identifier or a location of the slice or tile of the encoded bitstream included in the payload of each network packet 122.

Additional metadata may also be included in packets of the network packet sequence 122 that indicate a mapping between the logical sequence numbers of the payloads of the network packets and the transmission order of the network packets in the network packet sequence 122. As described in further detail herein, in some implementations the packetizer 116 can reorder the payloads of each RTP packet within the network packets in the network packet sequence 122 prior to transmission to the receiver device 101. In such implementations, the packetizer 116 can include additional metadata information in each network packet of the network packet sequence 122 to provide a mapping for correctly reordering the packets in the correct logical order to reconstruct the video frame.

The additional metadata may include an identifier of the sequence and an identifier of the proper logical position (e.g., the position of the payload prior to reordering) of the payload within the network packet sequence 122. In some implementations, the additional metadata may be provided in additionally generated network packets that are included in the network packet sequence 122 or in network packets transmitted as part of establishing the streaming session between the streaming system 110 and the receiver device 101.

In some implementations, the packetizer 116 can generate the network packet sequence 122 to accommodate various characteristics of the network. The network packet sequence 122 may include transport protocol packets that may not guarantee reliability of packet delivery. One example of such a protocol is UDP. An advantage of utilizing packets that do not guarantee delivery is decreased latency due to the lack of built-in error checking and reliability checks performed when using transport protocols that guarantee delivery of packets. In some implementations, the packetizer 116 may generate the network packet sequence 122 to include payloads with video streaming protocol data that satisfies the size of the maximum transmission unit (MTU) of the network 118, which is the maximum size of a packet that can be transmitted over the network without being fragmented. To do so, the packetizer 116 may, in some implementations, split the encoded bitstream into multiple RTP payloads to satisfy the MTU. In some implementations, multiple payloads of RTP packets with custom metadata can be included in each of the network packets of a network packet sequence 122. In some implementations, a network packet sequence 122 may correspond to a single video frame of the video data 112.

The packetizer 116 can generate the error correction data 120 for transmission with the network packets of the network packet sequence 122 that store the encoded bitstream of the frames of the video data 112. The error correction data 120 may be utilized by the receiver system 101 to correct errors that may occur during data transmission. Once network packets have been generated, the packetizer 116 can generate error correction data 120, which may include FEC data. The error correction data 120 can include encoded redundant payloads of the network packet sequence 122 generated by the packetizer 116.

In the example of FEC, the packetizer 116 can generate the error correction data 120, which may be included in packets of a network packet sequence 122 that carry encoded regions of a video frame. In some implementations, the packetizer 116 can generate additional network packets that include the error correction data 120 in additional payloads in the network packet sequence 122. To generate the error correction data, the packetizer 116 can apply an FEC encoding algorithm to the payload data of the network packets of a network packet sequence 122 that include the encoded bitstream data. Some example encoding algorithms include Reed-Solomon encoding, Hamming encoding, Low-Density Parity-Check (LDPC) encoding, Turbo encoding, Raptor encoding, Tornado encoding, Fountain encoding, Convolutional encoding, Bose-Chaudhuri-Hocquenghem (BCH) encoding, Golay encoding, and Polar encoding, among others. In some implementations, the packetizer 116 can generate error correction data 120 for a predetermined percentage of network packets in the network packet sequence 122.

In a non-limiting example where a video frame has a 20% bandwidth “budget” for error correction data 120, the packetizer 116 may generate a number of packets carrying error correction data 120 equal to 20% of the generated network packets of a network packet sequence 122 for the video frame. A weighted proportion of the generated error correction data 120 for the video frame may be generated for network packets carrying selected regions of the video frame, while the remainder of the error correction data 120 budget may be generated for network packets 122 carrying unselected regions of the video frame. In one example, 75% of the error correction data 120 for a network packet sequence 122 carrying data for a video frame may be generated for network packet(s) 122 carrying selected region(s) of the video frame, while the remaining 25% can be generated for the remaining network packet(s) 122 carrying unselected region(s) of the video frame.

Once the error correction data 120 has been generated, the packetizer 116 can determine a transmission order for the network packet sequence 122 based on the network packets that correspond to a selected region of a video frame included in the payloads of the network packet sequence 122, and based on the error correction data 120 generated for the network packet sequence 122. As described herein, burst loss may affect the sequences of network packets by dropping entire ranges of packets. In order to mitigate loss of important regions of data in the network packet sequence 122, which may include the error correction data 120, the network packet sequence 122 can be reordered to provide robustness against potential burst loss.

Burst loss may affect network packet sequences 122 predominately towards the end of the network packet sequence 122. This may be caused when traffic shaping or bandwidth control are applied by one or more intermediate routers in the network 118. Other intermediate network issues, such as network congestion or channel interference over Wi-Fi networks, may also cause burst loss, which may occur for any consecutive set of packets in a network packet sequence 122 corresponding to an encoded bitstream of video data 112. In some implementations, because burst loss may be more likely to affect the last packets in the network packet sequence 122, the packetizer 116 can determine the transmission order of the packets in the network packet sequence 122 such that packets including the error correction data 120 are included as the first packets transmitted as part of the network packet sequence 122. This increases the likelihood that the packets including the error correction data 120 will be received by the receiver device 101, which can utilize the error correction data 120 to reconstruct packets of the network packet sequence 122 that were delayed, lost or corrupted during transmission. This approach may be extended to include both selected regions of video data and corresponding error correction data as the first transmitted packets.

As described herein, the payloads of certain packets of the network packet sequence 122 may store selected regions of a video frame (e.g., important regions of the video frame). The packetizer 116 may receive indications of which portions of the encoded bitstream are selected regions. In some implementations, the packetizer 116 can determine the transmission order for a network packet sequence 122 carrying video data for a frame to mitigate burst loss of selected regions of the frame. To do so, the network packet sequence 122 may reorder the packets of the network packet sequence 122 such that the packets carrying the selected regions of the video frame are included as the first packets transmitted as part of the network packet sequence 122. In some implementations, packets of the network packet sequence 122 carrying the selected regions of the video frame and error correction data 120 generated for those packets may also be included as the first packets in the transmission order. This increases the likelihood that the packets including the selected regions of the video frame will be received by, or can be reconstructed by, the receiver device 101, enabling the receiver device to render those selected regions verbatim, reducing the perceptual impact to the end-user.

In some implementations, determining the transmission order for the network packet sequence 122 may be performed to maximize the acceptable burst loss length of the network packet sequence 122, and therefore improve the robustness of the network packet sequence 122 against smaller burst losses. The maximum acceptable burst loss length is the number of packets in the network packet sequence 122 that may be lost in sequence without significantly impacting the end-user experience. In such implementations, the packetizer 116 may treat packets of the network packet sequence 122 that store error correction data 120 generated for packets that carry selected regions of a video frame as “important” packets, for which loss should be minimized.

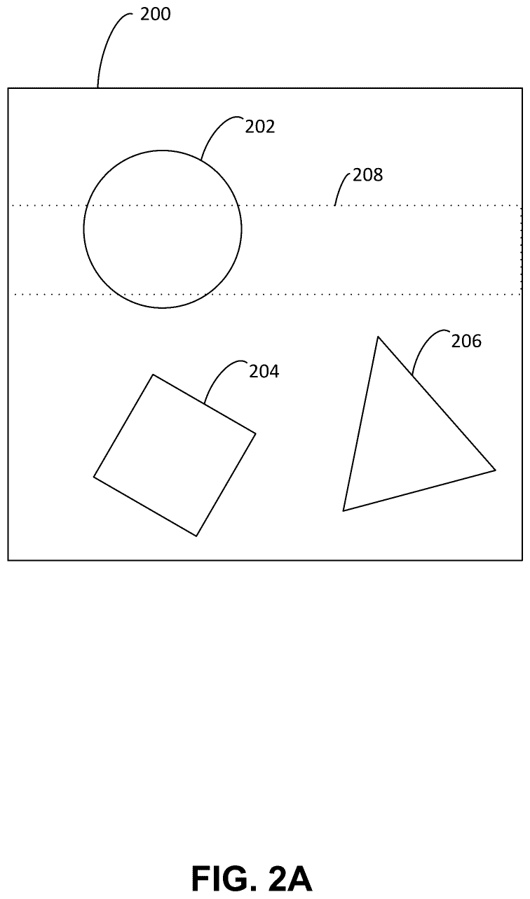

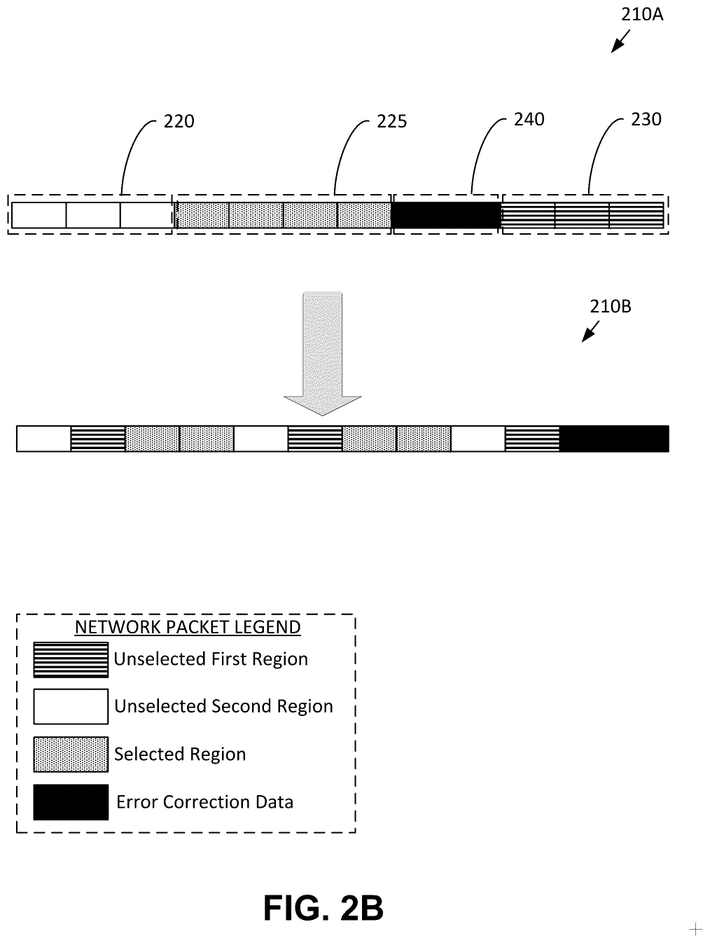

Determining the transmission order to maximize acceptable burst loss length may be a function of the number of packets in the network packet sequence 122, the number of important packets in the network packet sequence 122, and the error correction ratio for packets in the network packet sequence 122 for which error correction data 120 is generated in accordance with that ratio. To maximize the acceptable burst loss length of a network packet sequence 122 carrying a video frame, both packets carrying selected regions of the video frame and error correction data 120 generated for said packets may be reordered in the sequence to be interleaved with other “unimportant” packets. In doing so, the packetizer 116 can attempt to maximize the distance between clusters selected packets of the network packet sequence 122. An example of ordering of network packets in a network packet sequence 122 to increase maximum acceptable burst loss length is shown in FIG. 2B.

In some implementations, the packetizer 116 can determine the number of important packets and the total number of packets in the network packet sequence 122, to determine the number of unimportant packets that should be transmitted between groups of important packets. In some implementations, packets of the network packet sequence 122 carrying error correction data 120 may be reordered in the sequence to be transmitted first, while the other important and unimportant packets can be positioned in transmission order for the network packet sequence 122 to maximize acceptable burst loss length. To do so, after positioning the error correction data 120 packets as the first packets in the transmission order, the other packets including video data can be inserted in the transmission order such that the average distance between each important packet from other important packets in the transmission order is maximized.

In doing so, the important packets may be interleaved with unimportant packets in the network packet sequence 122. The number of unimportant packets in the network packet sequence 122 may be determined by subtracting the number of important packets in the network packet sequence 122 from the total number of packets in the network packet sequence 122. In some implementations, the packets including the error correction data 120 may be considered “important” packets, and therefore the transmission order of the network packet sequence 122 may be determined based at least on the number of packets including the error correction data 120 in the network packet sequence 122.

In some implementations, the packetizer 116 can determine the transmission order for the network packet sequence 122 such that a first set of network packets that carry data that encodes an unimportant region of the video frame are interleaved with a second set of packets that carry data that encodes another, equally unimportant region of the video frame. For example, when arranging the packets in the network packet sequence 122 according to the transmission order such that the average distance between clusters of important packets is maximized, the packetizer 116 can further interleave the packets that encode the top and bottom of the frame, assuming that they are of equal (un) importance. Such interleaving may include alternating packets that encode top portions of the frame with those that encode corresponding bottom portions of the frame. The result of interleaving packets in the network packet sequence 122 that encode the top and bottom portions of the frame is symmetric tearing of the video frame, if any sequences of packets are dropped due to burst lost in the network 118.

The packetizer 116 may utilize various approaches to reorder the network packet sequence 122 once the transmission order for the payloads stored therein has been determined. In some implementations, the packetizer 116 may reorder the network packet sequence 122 according to the determined transmission order after the network packet sequence 122 has been generated. To do so, the packetizer may store each packet in the network packet sequence 122 in an output queue or a similar container data structure in an order that corresponds to the determined transmission order. When the receiver device 101 receives the network packet sequence 122 the rearranged order, the receiver device 101 can rearrange the payloads in the network packet sequence 122 according to the sequence number in the RTP packets to reconstruct the bitstream encoding the frame of the video data 112.

In some implementations, the payloads for the network packet sequence 122 may be rearranged according to the transmission order prior to generation of the network packet sequence 122. To do so, the packetizer 116 may reorder portions of the encoded bitstream from which the RTP payloads of the network packet sequence 122 are to be generated and subsequently generate the RTP payloads using the reordered payload data. In doing so, the packetizer 116 distributes the payloads across the network packet sequence 122. To enable the receiver device 101 to properly reconstruct the logical order for the payloads (e.g., the order in which the payloads were originally intended to be transmitted), the packetizer 116 may include additional metadata in the network packet sequence 122, which includes a mapping between the packet sequence numbers of the RTP packets to the correct logical order of the payloads that make up the encoded video frame. The receiver device 101 can then reorder the payloads according to the mapping provided in the additional metadata. The additional metadata may be encoded within one or more network packets of the network packet sequence 122, or in additional network packets transmitted to the receiver device 101.

Once the network packet sequence 122 has been generated by the packetizer 116, the network packet sequence 122 can be transmitted to the receiver system 101 according to the transmission order. In implementations where the packetizer 116 reorders the packets following generation of the network packet sequence 122, the packetizer 116 may reorder and store the packets of the network packet sequence 122 by storing each packet into an output queue or a similar container data structure in the order designated by the transmission order. The network interface 117 can then access the output buffer or queue and transmit the packets in the network packet sequence 122 in the order in which they are stored.

In implementations where the packet payloads are rearranged prior to generation of the network packet sequence 122, the packetizer can store the packets of the network packet sequence 122 in the output buffer or a similar container data structure in the order in which they are generated without reordering the network packets. The network interface 117 can then access the output buffer or queue and transmit the packets in the network packet sequence 122 in the order in which they are stored. In some implementations, the packetizer 116 may retransmit one or more network packets to the receiver device 101 upon receiving a request for transmission of said network packet from the receiver system 101 (e.g., if the network packet was lost or corrupted during transmission). The network interface 117 of the streaming system 110 may include any of the structure of, and implement any of the functionality of, the communication interface 418 described in connection with FIG. 4.

The receiver system 101 may be any computing system suitable to receive and process sequences of network packets transmitted by the streaming system 110. The receiver system 101 can receive the one or more packets of the network packet sequence 122 via the network interface 119. The network interface 119 of the receiver system 101 may include any of the structure of, and implement any of the functionality of, the communication interface 420 described in connection with FIG. 4. In some implementations, the receiver system 101 may include or may be in communication with a display device that can present decoded video data generated based at least on payload data of the network packet sequence 122. The decoded video data may be, for example, video data generated from a remote game or remote application executing on the streaming server.

The depacketizer 104 of the receiver system 101 can receive the network packet sequence 122 transmitted from the streaming system 110 and assemble one or more decodable units of video data to provide to the decoder 106. As described herein, packets of the network packet sequence 122 may be transmitted in an order that is different from an order in which the data stored therein should be processed. The depacketizer 104 can therefore reorder the payload data of the network packet sequence 122 to assemble the encoded bitstream corresponding to the video data 112.

In implementations where the network packets of the network packet sequence 122 were reordered after the network packets were generated, the depacketizer 104 can store and reorder the RTP packets included in the received network packet sequence 122 according to the sequence numbers of the RTP packets. The sequence number may be a value included in the header of each RTP packet that can be utilized to identify and to specify a proper order for the payload of the RTP packet. To reconstruct the RTP payloads in the proper order, the depacketizer 104 can extract the sequence number from each RTP packet header in network packet sequence 122 and can store the RTP packets in a buffer or a similar container data structure, indexed by the sequence number of each RTP packet. As additional packets of the network packet sequence 122 are received, the depacketizer 104 can access the sequence number in the header of each RTP packet and store the RTP packet in the buffer in the correct order. For example, the sequence number may be a number that is incremented each time an RTP packet is generated, and therefore the depacketizer 116 may store the RTP packets (or the payloads stored therein) by increasing sequence number. In some implementations, the depacketizer 104 may discard any duplicate packets.

In implementations where the payloads of the network packet sequence 122 were reordered prior to generation of the network packet sequence 122, the depacketizer 116 may access additional metadata transmitted by the streaming system 110 to reorder the packets in a correct logical order. As described herein, the additional metadata in the network packet sequence 122 includes a mapping between the packet sequence numbers of the RTP packets in the received network packet sequence 122 and the logical order of the payloads that make up the encoded bitstream. To reconstruct encoded bitstream from the network packet sequence 122, the depacketizer 104 can extract the payloads from each RTP packet along with the corresponding sequence number for the RTP packet (e.g., the sequence number which corresponds to the transmission order of the packet). The depacketizer 116 can then utilize the mapping in the additional metadata and the extracted sequence numbers to store the payloads in memory in the correct order. As additional packets of the network packet sequence 122 are received, the depacketizer 104 can access the sequence number and the additional metadata to assemble the encoded bitstream for the frame of video data 112.

Once the payloads of the network packet sequence 122 have been assembled in the proper order, the depacketizer 104 can assemble the encoded bitstream by concatenating the payloads together. The encoded bitstream may correspond to a frame of the video data 112. In some implementations, the depacketizer 104 can utilize any received error correction data 120 to reconstruct any lost payload data. For example, in addition to storing the payload data corresponding to the video stream in a buffer, the depacketizer 104 can store any received error correction data 120 in one or more data structures in memory of the receiver system 101 and perform a corresponding decoding algorithm to decode the information encoded in the error correction data 120. After recovering the lost or corrupted payload data using the decoding process, the depacketizer 104 can store the reconstructed data as part of the encoded bitstream in the memory of the receiver device 101. Once the encoded bitstream has been assembled, the depacketizer 104 can provide the encoded bitstream to the decoder 106.

The decoder 106 can receive, parse, and decode the encoded bitstream assembled by the depacketizer 104. To do so, the decoder 106 can parse the encoded bitstream to extract any associated video metadata, such as the frame size, frame rate, and audio sample rate. In some implementations, the decoder 106 can identify the codec based at least on the metadata and decode the encoded bitstream using the identified codec to generate data video and/or audio data. In some implementations, such video metadata may be transmitted in one or more packets that are separate from the network packets 122 that include video data. This may include decompressing or performing the inverse of any encoding operations used to generate the encoded bitstream at the streaming system 110. The decoder 106, upon generating the decoded video data for a frame of video, can provide the decoded video frame data to the renderer 108 for rendering. In circumstances where video data is lost due to lost or corrupted network packets 122, the decoder 106 may implement one or more error concealment techniques to conceal errors in the ultimately rendered video.

The renderer 108 can render and display the decoded video data received from the decoder 106. The renderer 108 can render the decoded video data on any suitable display device, such as a monitor, a television, or any other type of device capable of displaying decoded video data. To do so, the renderer 108 can store the decoded video data in a frame buffer. The renderer 108 can then draw the frame buffer contents for the current frame to the display device. In some implementations, the renderer 108 may perform multiple layers of rendering, such as overlaying graphics or text on top of the video frames. In circumstances where video data is lost due to lost or corrupted network packets 122, the renderer 108 may implement one or more error concealment techniques to conceal errors in the ultimately rendered video.

Referring to FIG. 2A, depicted is an example diagram of a video frame 200 constructed from encoded regions 208 that may be rendered by the system shown in FIG. 1, in accordance with some embodiments of the present disclosure. As shown in FIG. 2, the frame 200 is shown depicting displayed objects such as the circle 202, the square 204, and the triangle 206 in initial positions. Other display elements such as displayed background are not shown for clarity. In this non-limiting example, a region 208 of the frame 200 is a horizontal slice that spans the width of the frame 200. The frame 200 includes other slices having the same width but are located at different locations of the frame 200. However, it should be understood that regions of the video frames described herein may include any geometric shape or configuration, such as rectangular or square tiles. Multiple frame regions are rendered together to form a complete, seamless image. Packets that store each region of the frame 200 may be reordered prior to transmission according to the techniques described herein.

Referring to FIG. 2B, depicted is an example diagram showing how packets in a sequence 210A of network packets may be reordered to generate the reordered sequence 210B in order to maximize burst loss robustness, in accordance with some embodiments of the present disclosure. As shown, the sequence 210A may include packets of different levels of “importance”, represented in FIG. 2B as blocks having different shading patterns, including a first group of packets 220 containing data for the first set of unimportant frame regions, a second group of packets 225 containing data for selected (e.g., important or relevant) frame regions, a third group of packets 230 containing data for the second set of unimportant frame regions, and a fourth group of packets 240 containing error correction data (e.g., error correction data 120) generated for the other packets in the sequence 210A.

In the example shown in FIG. 2B, the sequence 210A may be generated by the packetizer 116 according to the techniques described herein, and includes ten packets carrying video data (the groups 220, 225, and 230) and two additional packets carrying error correction data (the group 240), with the second group 225 of selected packets having four packets. The transmission order of the sequences 210A and 210B may be chronological from right to left, with the right-most packets in the sequences 210A and 210B being transmitted first, and the left-most packets in the sequences 210A and 210B being transmitted last. In some implementations, each of the packets represented the groups 220, 225, 230, and 240 may include both video and error correction data.

To maximize acceptable burst loss length, the transmission order of the sequence 210A can be rearranged such that the group 240 carrying error correction data is transmitted first, followed by clusters of the important packets in the second group 225 that are interleaved with less important packets (in groups 220 and 230), thus maximizing the temporal distance between transmission of important packets in the sequence. In some implementations, this may include interleaving clusters of important packets with clusters of unimportant packets, to increase the number of sequential packets in the sequence that may be lost in a burst while simultaneously reducing the average number of important packets that would be lost due to the burst loss. The number of packets in each cluster, and the number of clusters or unimportant packets interleaved between the important packets, may be determined at least by the amount of error correction data (e.g., the error correction data 120) generated for the important packets in the sequence 210. Error correction data may be generated to enable recovery of a predetermined number of packets in the sequence 210A. The number of packets interleaved between the clusters of selected packets, along with the size of the clusters of the selected packets, may be determined at least based on the number of packets that may be recovered using the error correction data, assuming the error correction data arrives at the receiver device. (e.g., the receiver device 101).

The reordered version of the sequence 210A is shown as the sequence 210B, which indicates how the transmission order of the packets in the sequence 210A has been changed (e.g., by the packetizer 116) to maximize acceptable burst loss length. The selected packets previously in the second group 225 are divided into clusters, which are then subsequently interleaved with unimportant packets, as shown in the sequence 210B. The size of the clusters may be a function of the number of packets corresponding to important regions and the number of all packets in the network packet sequence 210A. Also as shown, the unimportant packets in the first group 220 and the second group 230 are distributed between the clusters of the important packets, as shown. In this example, the packets of the first group 220 have been interleaved about evenly with the packets from the third group 230, to result in a similar amount of tearing for affected unimportant regions if a burst loss occurs during transmission.

In this example, the group 240 of error correction packets are generated such that 20% error correction budget is applied only to the packets in the group 225, bringing the effective error correction rate of group 225 to 50%. As ten packets are present in the sequence 210A, the group 240 includes enough error correction data to reconstruct two lost packets that encode important network data. In the redistributed packet sequence 210B, the maximum random burst loss length is equal to four, because any consecutive set of four packets in the sequence 210B would include at most two important packets from the second group 225 or at most two of their related error correction packets from the fourth group 240. This is an improvement over the maximum random burst loss length of the sequence 210A, which in this example would be equal to two, due to the second group 225 including four consecutive important packets. As such, changing the order in which the packets in sequences are transmitted can reduce the visual impact of data lost during transmission and therefore improve the performance and experience of streaming systems.

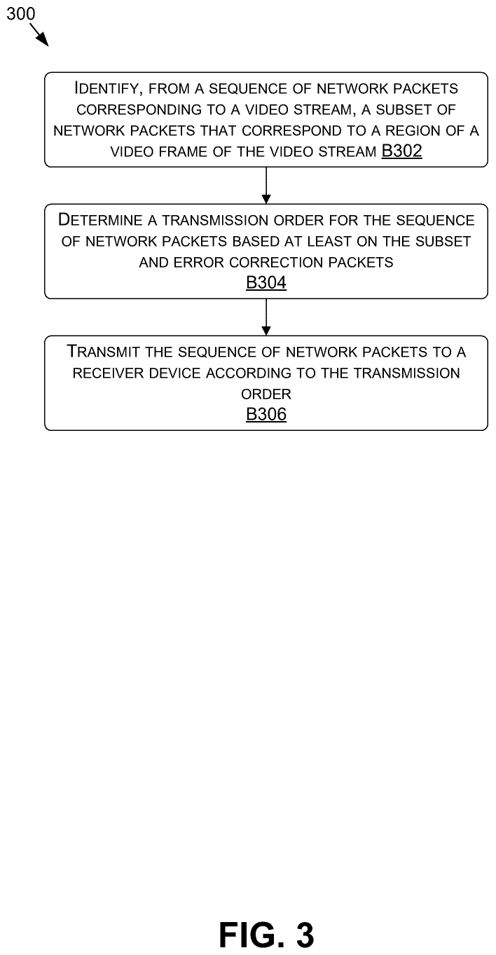

Now referring to FIG. 3, each block of method 300, described herein, includes a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for improving perceived video quality through temporal redistribution of network packet payloads that may carry error mitigation data, in accordance with some embodiments of the present disclosure. The method 300, at block B302, includes identifying a subset of network packets from a sequence of network packets (e.g., a network packet sequence 122) that correspond to a region (e.g., the region 208) of a video frame of an encoded video stream (e.g., the video data 112). As described herein, the network packet sequence may be generated by a streaming server (e.g., the streaming system 110) for transmission to a receiver system (e.g., the receiver system 101).

The network packets may be UDP packets having payloads that include packets corresponding to a streaming protocol such as RTP, or any other streaming protocol that provides a mapping between subsets of frame regions and streaming protocol packets. The encoded bitstream can be encoded according to any suitable codec standard, including but not limited to codec standards such as h.264 (AVC), h.265 (HEVC), h.266 (VVC), AV1, VP8, VP9, or any suitable codec that supports geometrical regions (e.g., a continuous sequence of macroblocks) of a video frame. The encoded bitstream may encode regions of each frame of the video stream, where each region may be a slice (e.g., a horizontal slice) or a tile, which may have at least one dimension that is lesser than or equal to dimensions of the frame. To identify the network packets that correspond to the selected regions of the video, the streaming server (e.g., the packetizer 116 of the streaming system 110) can determine which regions of the video frame are most likely to be drawing the most attention from an end user and which packets include said encoded regions as part of their payloads.

The method 300, at block B304, includes determining a transmission order or the sequence of network packets based at least on the subset of network packets and one or more error correction packets. The error correction packet may be any network packet that includes error correction data (e.g., the error correction data 120). The error correction data may be FEC data, and may encode redundant information stored in the network packets that carry the encoded bitstream of the video. The transmission order can be the order in which the packets of the sequence of network packets are transmitted to the receiver device. In some implementations, the subset of the network packets and/or corresponding error correction packets can be placed first in the transmission order, because burst loss may be more likely to affect the last packets in the sequence of network packets.

The transmission order may be determined to maximize the acceptable burst loss length of the sequence of network packets, and therefore improve robustness against smaller burst losses. The maximum acceptable burst loss length is the number of consecutive packets that may be lost without significantly impacting the end-user experience. Significant impacts may include failing to receive or recover one or more packets that carry a selected region of a video frame. To maximize the acceptable burst loss length, clusters of the packets carrying selected regions of video frames may be interleaved in the transmission order with packets that carry less important regions of the video frame.

The size of the clusters, and the number of less important regions between each cluster, may be a function of at least the number of packets that include selected frame regions and the total number of packets in the sequence of network packets. In some implementations, packets including error correction data may be considered selected or important packets, and therefore the transmission order may be determined based at least on the number of error correction packets included in the sequence of network packets. In some implementations, the important packets (both from selected frame regions and/or related error correction data) may be positioned first in the transmission order, and the transmission order for other packets in the sequence may be reordered to maximize acceptable burst loss length.

The method 300, at block B306, includes transmitting the network packets to the receiver system according to the transmission order. To do so, the network packets may be transmitted via a network interface (e.g., the network interface 117) over a packet switching network (e.g., the network 118), which transmits each packet in the sequence according to the order in which the packets are stored in memory. In some implementations, the packets in the sequence may be rearranged and stored in an output buffer or queue according to the transmission order. In some implementations, the payloads of the packets may be rearranged according to the determined transmission order prior to generation of the network packets. The receiver device can then receive the sequence of network packets and reconstruct the encoded bitstream stored therein. The encoded bitstream can then be decoded (e.g., by the decoder 106) and rendered (e.g., by the renderer 108).

### Example Content Streaming System

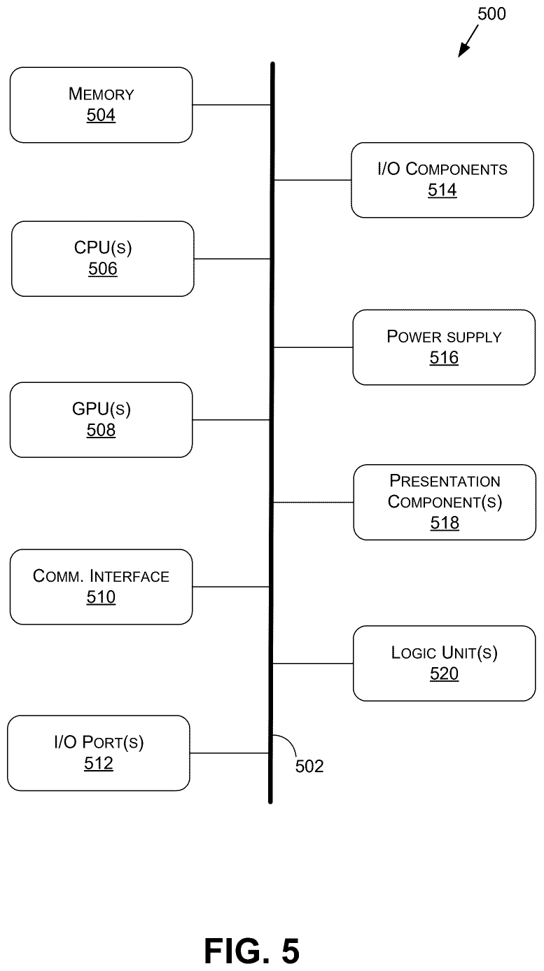

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 100 may be implemented by one or more components of the system 400 shown in FIG. 4. The application session may correspond to a game streaming application (e.g., NVIDIA Geforce NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 400, for an application session, the client device(s) 404 may only receive input data in response to inputs to the input device(s) 426, transmit the input data to the application server(s) 402, receive encoded display data from the application server(s) 402, and display the display data on the display 424. As such, the more computationally intense computing and processing is offloaded to the application server(s) 402 (e.g., rendering—in particular, ray or path-tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based at least on receiving the display data from the application server(s) 402. The application server(s) 402 may implement any of the functionality of the streaming server 110 described in connection with FIG. 1. The client device 404 may receive an input to one of the input device(s) 426 and generate input data in response. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data), and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424. The client device 404 may implement any of the functionality of the receiver system 101 described in connection with FIG. 1.

The systems and methods described herein may be used for a variety of purposes, by way of example and without limitation, machine control, machine locomotion, machine driving, synthetic data generation, one or more language models, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing, and/or any other suitable applications.

Disclosed embodiments may be used in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems incorporating one or more language models, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may include one or more virtual machines (VMs), and/or any of the components thereof may include virtual components (e.g., virtual hardware components). For non-limiting examples, one or more of the GPUs 508 may include one or more vGPUs, one or more of the CPUs 506 may include one or more vCPUs, and/or one or more of the logic units 520 may include one or more virtual logic units. As such, a computing device 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may include computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be implemented/configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be implemented/configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506) and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLink) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be implemented/configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., to a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. A NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.) and output the data (e.g., as an image, video, sound, etc.).

### Example Data Center

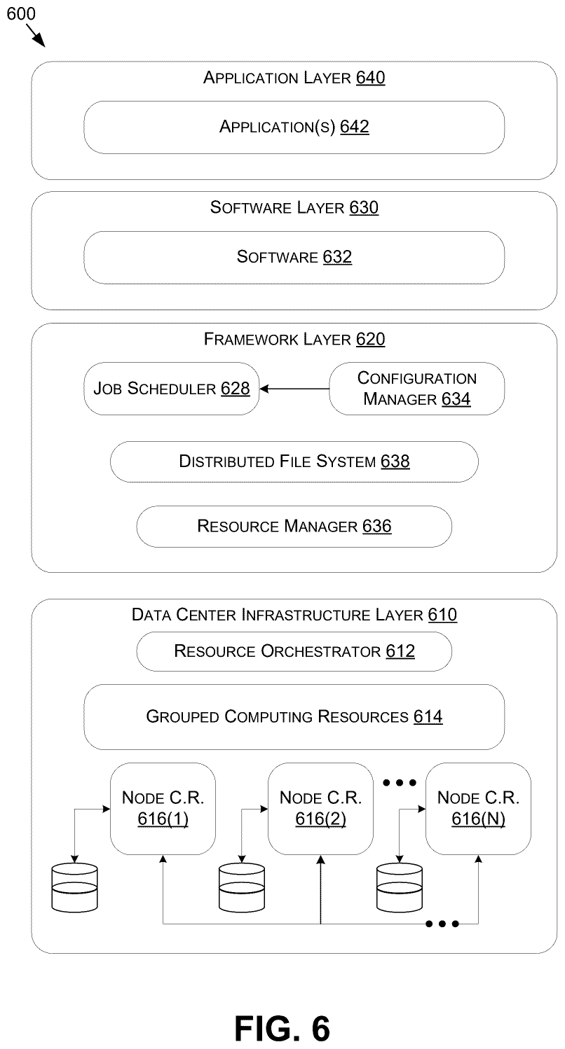

FIG. 6 illustrates an example data center 600 that may be used in at least one embodiment of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory, or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resources 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based at least on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or a combination thereof. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, the functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
identify, from a sequence of network packets corresponding to an encoded video stream, a subset of network packets corresponding to a region of a video frame of the encoded video stream;
determine a transmission order for the sequence of network packets based at least on the subset of network packets and one or more error correction packets corresponding to the sequence of network packets; and
transmit the sequence of network packets to a receiver client device according to the transmission order.

2. The processor of claim 1, wherein the one or more circuits are to reorder one or more payloads of the sequence of network packets according to the transmission order prior to encoding the sequence of network packets for transmission.

3. The processor of claim 1, wherein the one or more circuits are to reorder one or more packets of the sequence of network packets according to the transmission order prior to transmitting the sequence of network packets to the receiver client device.

4. The processor of claim 1, wherein the one or more circuits are to generate the one or more error correction packets based at least on the encoded video stream for inclusion in the sequence of network packets.

5. The processor of claim 4, wherein the one or more circuits are to determine the transmission order for the sequence of network packets further based at least on a number of the one or more error correction packets.

6. The processor of claim 4, wherein the one or more error correction packets are related to the subset of the network packets, and wherein the one or more circuits are to determine the transmission order such that at least one of the subset of the network packets or the one or more related error correction packets are transmitted prior to other packets of the sequence of network packets.

7. The processor of claim 1, wherein the one or more circuits are to determine the transmission order such that a first set of packets corresponding to a first unprioritized region of the video frame is interleaved with a second set of packets corresponding to a second unprioritized of the video frame.

8. The processor of claim 1, wherein the one or more circuits are to determine the transmission order further based at least on a length of the sequence of network packets.

9. The processor of claim 1, wherein the one or more circuits are to determine the transmission order such that one or more of the subsets of network packets are separated by one or more other packets of the sequence of network packets.

10. The processor of claim 9, wherein the one or more circuits are to determine a number of the one or more other packets according to a number of the subset of network packets.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 4D assets;
a system for performing deep learning operations;
a system implemented using an edge device;
a system implemented using a robot;
a system for performing conversational AI operations;
a system for generating synthetic data;
a system incorporating one or more language models;
a system incorporating one or more virtual machines (VMs);
a system implemented at least partially in a data center; or
a system implemented at least partially using cloud computing resources.

12. A system comprising:
one or more processing units; and
one or more memory units storing instructions that, when executed by the one or more processing units, cause the one or more processing units to execute operations comprising:
identifying, from a sequence of network packets corresponding to an encoded video stream, a subset of network packets corresponding to a region of a video frame of the encoded video stream;
determining a transmission order for the sequence of network packets based at least on the subset of network packets and one or more error correction packets corresponding to the sequence of network packets; and
transmitting the sequence of network packets to a receiver client device according to the transmission order.

13. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more language models;
a system incorporating one or more virtual machines (VMs);
a system implemented at least partially in a data center; or
a system implemented at least partially using cloud computing resources.

14. The system of claim 12, wherein the instructions, when executed by the one or more processing units, cause the one or more processing units to generate the one or more error correction packets based at least on the encoded video stream for inclusion in the sequence of network packets.

15. The processor of claim 14, wherein the instructions, when executed by the one or more processing units, cause the one or more processing units to determine the transmission order for the sequence of network packets further based at least on a number of the one or more error correction packets.

16. The processor of claim 14, wherein the instructions, when executed by the one or more processing units, cause the one or more processing units to determine the transmission order such that at least one of the subset of the network packets or the one or more error correction packets are transmitted prior to other packets of the sequence of network packets.

17. The processor of claim 1, wherein the instructions, when executed by the one or more processing units, cause the one or more processing units to determine the transmission order such that a first set of packets corresponding to a first unprioritized region of the video frame are interleaved with a second set of packets corresponding to a second unprioritized region of the video frame.

18. The processor of claim 1, wherein the instructions, when executed by the one or more processing units, cause the one or more processing units to determine the transmission order further based at least on a length of the sequence of network packets.

19. The processor of claim 1, wherein the instructions, when executed by the one or more processing units, cause the one or more processing units to determine the transmission order such that one or more of the subsets of network packets are separated by one or more other packets of the sequence of network packets.

20. A method, comprising:
identifying, using one or more processors, from a sequence of network packets corresponding to an encoded video stream, a subset of network packets corresponding to a region of a video frame of the encoded video stream;
determining, using the one or more processors, a transmission order for the sequence of network packets based at least on the subset of network packets and one or more error correction packets corresponding to the sequence of network packets; and
transmitting, using the one or more processors, the sequence of network packets to a receiver client device according to the transmission order.
